(19) United States
(12) Patent Application Publication
(10) Pub. No.: US 2016/0177827 A1
(43) Pub. Date: Jun. 23, 2016

(54) GAS TURBINE POWER PLANT MADE FLEXIBLE

(71) Applicant: SIEMENS AKTIENGESELLSCHAFT, München (DE)

(72) Inventors: Christian Brunhuber, Auerbach (DE); Carsten Graeber, Erlangen (DE); Uwe Lenk, Zwickau (DE); Klaus Werner, Goch (DE); Gerhard ZIMMERMANN, Hochstadt/Aisch (DE)

(73) Assignee: Siemens Aktiengesellschaft, Munich (DE)

(21) Appl. No.: 14/907,654

(22) PCT Filed: May 8, 2014
(86) PCT No.: PCT/EP2014/059454

§ 371 Date: Jan. 26, 2016

(30) Foreign Application Priority Data
Aug. 1, 2013 (DE) 10 2013 215 083.0

(51) Int. Cl. F02C 7/10; F02C 9/16

(52) U.S. Cl. CPC F02C 7/10; F02C 9/16

(57) ABSTRACT

A gas turbine power plant includes a gas turbine having a compressor, combustion chamber, and expander and is rotationally mechanically coupled to an energisation unit designed for motor operation of the compressor and for electricity-generating generator operation of the gas turbine. The power plant includes a recuperator, thermally connected to an exhaust-gas discharge line of the turbine such that heat is transferred from the exhaust-gas flow in the exhaust-gas discharge line to a fluid flow in a fluid line during operation, which fluid flow is fed to the combustion chamber. A supply line is fluidically connected to the turbine such that water is supplied to the turbine to increase operating mass flow during operation. The exhaust-gas discharge line is thermally coupled to at least one heat accumulator, such that, during operation, heat of the exhaust-gas flow is transferred to a heat accumulator medium for storage in the heat accumulator.

### CROSS REFERENCE TO RELATED APPLICATIONS

This application is the US National Stage of International Application No. PCT/EP2014/059454 filed May 8, 2014, and claims the benefit thereof. The International Application claims the benefit of German Application No. DE 102013215083.0 filed Aug. 1, 2013. All of the applications are incorporated by reference herein in their entirety.

### FIELD OF INVENTION

The present invention relates to a gas turbine power plant which, for improved flexibility, has a gas turbine that is thermodynamically connected to a recuperator, and a feed line for water. The present invention further relates to a method for operating such a gas turbine power plant.

### BACKGROUND OF INVENTION

As a consequence of the rapid development of temporally fluctuating, renewable energy sources for providing electrical energy in power supply grids, some countries and regions of Europe are already experiencing problems in ensuring grid stability. Due to the large temporal variations in quantities of excess current from these renewable energy sources, and due to a relatively low number of other feeding-in energy sources which could serve for equalizing the fluctuating excess current, it is increasingly necessary to have grid services for equalizing these fluctuating energy quantities.

Some of the time, fossil fuel power plants are kept ready as a grid reserve for the renewable energy sources, in order that these can compensate for the deficit at times when feed-in from the renewable energy sources is reduced. However, since fossil fuel power plants increasingly suffer from decreasing workload and thus reduced economic viability, further measures are required in order to achieve grid stability, for example by retrofitting and increasing the flexibility of the renewable energy sources or by grid development and establishment of phase shifters (synchronous generators). In addition, use is also increasingly made, for grid stabilization, of increased-flexibility gas-and-steam power plants (combined-cycle power plants) with simplified steam circuits (Flex-Plants).

However, the problem with these approaches is that in particular fossil fuel power plants are configured only in a very limited manner for short-term operation and thus for short-term grid stabilization. In particular on account of the typically high preparation times, which can be in the range of some hours, fossil fuel power plants are suitable for these tasks only with poor economic conditions. The economic viability of operating these power plants known from the prior art is disadvantageous due to frequently insufficient efficiencies during electricity production.

For that reason, there are currently under consideration numerous other technical measures which can contribute to improved flexibility and increased efficiency of existing energy infrastructure. One method, which in the field of energy generation by means of gas turbines is suitable for the provision of short-term control power, is the injection of water or steam (=water steam) into the gas turbine in order to increase the mass flow to be expanded in the expander of the gas turbine. To that end, liquid water or steam is introduced into the compressor or into the combustion chamber of the gas turbine and, possibly after transition into the gas phase, is expanded in the expander together with the combustion exhaust gases. Due to the increase in the mass flow, the mechanical expansion power is also increased in the short term, resulting in increased output of electrical power for the time during which water or steam is injected into the gas turbine. A gas turbine power plant of this type is known for example from DE 10 2011 001 766 A1.

In order to increase the efficiency of existing gas turbine power plants, there may for example be provided a recuperator which reuses the thermal energy of the exhaust gas removed from the expander for the thermal preparation of other fluids. In particular, the thermal energy which is still present in the exhaust gas of a gas turbine can be used for the preparation of steam, which takes place in a steam process, coupled to the gas turbine process, for reconversion.

If the operation of such a recuperator is combined with the above-described injection of water into a gas turbine, it is possible to obtain a significant increase in efficiency since the water injected into the gas turbine is heated in the gas turbine, and this water thus heated permits a high heat transfer rate in the recuperator. The heat transfer rate is in this case greater than in the case of a transfer of heat from a comparatively “dry” exhaust gas at the same temperature. The combination of injected water and recuperator can thus permit a synergistic increase in efficiency. Such operation of a gas turbine is typically also termed a “Regenerated Water Injected” (RWI) gas turbine process.

Both of the above-described measures for increasing flexibility and raising efficiency are known for example from U.S. Pat. No. 4,928,478. Comparable measures may also be found for example in the published doctoral thesis of Markus Them, published at Lund University on Dec. 12, 2005 with the title “Humidification process in gas turbine cycles”.

Although the measures for increasing flexibility and raising efficiency described in the prior art already offer advantageous approaches, in order to better use a gas turbine power plant for grid stabilization, with respect to its operating mode, there are nonetheless still deficits which require even greater flexibility or increase in efficiency. Thus, the measures known from the prior art can propose no technical solution approaches for example for using or equalizing existing excess quantities of electrical energy in the public electricity supply grids. However, precisely this kind of use increasingly proves to be of economic interest since these quantities of excess energy can be made available with economic advantages, i.e. even for a fee.

Furthermore, the solution measures known from the prior art permit only a direct reaction to the changing supply of and demand for electrical energy in the power supply grids. Thus, if for example there is an increased demand for energy, it is possible, by targeted injection of water or steam into a gas turbine, to increase the provision of electrical energy in order to satisfy the demand. The demand existing at a given time is thus always responded to with a reaction in direct temporal connection therewith. However, according to these solution proposals, energy quantities which for example are more economically advantageous at other times cannot be used for grid stabilization.

Furthermore, it remains to be noted that a great number of gas turbine power plants are operated in regions of the Earth which receive large amounts of solar irradiance. Moreover, it would be desirable in these regions to make a gas turbine power plant flexible such that it is also possible to provide suitable cold power when, for instance, this is in demand. This cold power should also be provided by means of existing energy infrastructure.

Consequently, the technical problem is to avoid these drawbacks—known from the prior art—of gas turbine power plants, in particular to propose a gas turbine power plant with greater flexibility and a method for operating same.

### SUMMARY OF INVENTION

This problem, upon which the invention is based, is solved with a gas turbine power plant and a method for operating such a gas turbine power plant as claimed.

In particular, these problems, upon which the invention is based, are solved with a gas turbine power plant, comprising a gas turbine having a compressor, a combustion chamber and an expander, this gas turbine being rotationally coupled to an energizing unit, wherein the energizing unit is designed both for motive operation of the compressor and for current-generating, generative operation of the gas turbine, and furthermore a recuperator which is thermodynamically connected to an exhaust gas outlet line of the gas turbine such that, during operation of the gas turbine, heat from the exhaust gas stream in the exhaust gas outlet line is transferred to a fluid stream, in a fluid line, which is fed to the combustion chamber, wherein the fluid stream in the fluid line is essentially compressed air, and the fluid line is fluidically connected to the compressor, and wherein furthermore there is provided a feed line for water which is fluidically connected to the gas turbine such that water can be fed to the gas turbine during operation in order to increase the operating mass flow, and wherein the exhaust gas outlet line is moreover thermodynamically coupled to at least one heat store such that, during operation of the gas turbine, heat from the exhaust gas stream can be transferred to a heat storage medium to be stored in the heat store.

Moreover, the problem upon which the invention is based is solved with a method for operating such a gas turbine power plant which comprises the following steps:

during a first operating phase:—operating the energizing unit for generative current generation;—feeding water, by means of the feed line, to the gas turbine in order to increase the operating mass flow;—compressing fluid by means of the compressor and conveying the compressed fluid stream, by means of the fluid line, to the combustion chamber;—combusting the compressed fluid together with a fuel in the combustion chamber;—conveying the combustion products from the combustion chamber to the expander;—expanding the combustion products in the expander and removing the exhaust gas stream from the expander by means of the exhaust gas outlet line;—transferring heat from the exhaust gas stream to the fluid of the fluid stream by means of the recuperator;—transferring heat from the exhaust gas stream to a first heat storage medium by means of a first heat exchanger and storing the heat storage medium in the first heat store;

and during a second operating phase, which is not carried out at the same time as the first operating phase:—operating the energizing unit for motive driving of the compressor;—compressing air by means of the compressor and conveying the compressed air stream, by means of the fluid line, to the combustion chamber;—combusting the compressed air together with a fuel in the combustion chamber;—conveying the combustion products from the combustion chamber to the expander;—expanding the combustion products in the expander and removing the exhaust gas stream by means of the exhaust gas outlet line;—transferring heat from the exhaust gas stream to the fluid stream by means of the recuperator;—transferring heat from the exhaust gas stream to a first heat storage medium by means of the first heat exchanger and storing the heat medium in the first heat store.

At this point, it should be noted that here the operation of a gas turbine power plant or of a gas turbine is to be understood in general terms. Operation thus includes both motive operation and generative operation. Motive operation proceeds in this case from a conventional start operation, as is known for example from U.S. Pat. No. 4,702,074 A, and also permits continued operation of the compressor (together with the shaft mechanically coupled thereto, on which the expander may also be arranged) at setpoint rotational speeds which otherwise could be achieved only with a conventionally fired operation of the gas turbine. Typically, the energizing unit is thus embodied as a motor/generator.

Furthermore, the term heat is in the present case to be understood in general terms. Thus, for example, heat can be understood in the sense of positive thermal energy but also in the sense of negative thermal energy, that is to say cold.

According to the invention, the gas turbine power plant permits the use of heat from the exhaust gas stream by means of the recuperator. The recuperator makes it possible for at least part of this heat to be transferred to a fluid stream in a fluid line. The fluid stream is fed to the combustion chamber such that, after injection into the combustion chamber, the heat in the fluid stream can once again be made available for the gas turbine process. The fluid stream can in this case be, for example, an air stream, a humidified air stream or possibly also a mixture of air, water and fuel. Equally, the fluid stream can encompass a pure fuel fluid stream (e.g. natural gas or methane).

Raising efficiency or increasing the flexibility of the gas turbine power plant is initially to be understood as providing an energizing unit which is suitable both for motive operation, for example for driving the compressor, and for generative operation, for example for generating electric current. Thus, it is also possible to draw electric current from the power supply grids at times of excess power supply in order to supply this to a mechanical-thermal process. During motive operation of the compressor, air is compressed after being drawn into the gas turbine, and is conveyed to the combustion chamber. The compressed air can be fed to an expander, via which a thermal expansion takes place, with combustion of fuel or also in the absence of a combustion process. The thermal energy still residing in the exhaust gas stream can now once again be converted into useful thermal energy by means of the recuperator. In this process, for example, heat from the exhaust gas stream is fed back to the fluid stream which is conveyed to the combustion chamber. Equally, the heat from the exhaust gas stream can also be transferred by means of a first heat exchanger to a heat storage medium which is temporarily stored in the first heat store. By virtue of the temporary storage, the thermal energy thus provided is also available at a later time and can, when required, be reconverted by means of a suitable process. In addition, the heat store may also provide heat for suitable applications for combined heat and power. Thus, for example, the heat store can be connected to a district heating network or to installations for industrial and domestic heat use. Thus, the heat store has, for example, a thermodynamic and/or fluidic connection for a combined heat and power (cogeneration) installation which in particular is a district heating network.

The inventive feed line for water conveys water in possibly various aggregate states. Thus, water can be conveyed for example in liquid form or also in gaseous form or in the form of a mixture. Advantages are given, however, to conveying liquid water since this contributes, after injection into the gas turbine, to cooling the combustion gases. After injection or conveying to the combustion chamber and/or to the compressor of the gas turbine, the heat in the water is available for the gas turbine process during thermal expansion in the expander. In the following, water is to be understood as both liquid and gaseous water unless explicitly indicated.

Depending on the embodiment of the invention, the feed line can open both into the combustion chamber and/or into the compressor of the gas turbine.

The improved flexibility of the gas turbine power plant according to the present invention thus results on one hand from the plurality of different operating modes which the motive or generative operation of the energizing unit permits, and from the temporary storage of thermal energy, generated during a gas turbine process, in a heat store. The gas turbine process in question relates in this case to the plurality of different operating modes of the gas turbine. The provision of the heat store also permits the use of heat in further heat processes, in particular in connection with combined heat and power installations.

According to the invention, it is provided that the fluid stream in the fluid line is essentially compressed air, wherein the fluid line is fluidically connected to the compressor. The fluid line thus makes it possible to remove compressed air from the compressor and to then feed it, after thermal preparation by means of the recuperator, to the combustion chamber. In a further embodiment, it can also be provided that water in the form of steam is added to the fluid stream. Thus, there can be conveyed in the fluid line an air-water mixture which, in the combustion chamber, can for example be combusted together with a fuel. The water serves as a moderator during combustion but as a cold medium during expansion. In that context, the following embodiment also proves to be particularly advantageous.

According to this embodiment, it is provided that there is further comprised a water line which opens into the fluid line and, during operation of the gas turbine, can supply water to the fluid stream in the fluid line. In this context, the water line can convey water equally in liquid form or in gaseous form (steam), or in the form of a mixture. In particular, the water line opens into the fluid line between the compressor and the recuperator. Thus, the water conveyed to the fluid line via the water line can also be thermally prepared in the recuperator. Once the air-water mixture has been conveyed to the combustion chamber, according to the embodiment it is no longer necessary to mix the individual components since a generally sufficient mixing has taken place in the fluid line.

According to a further embodiment of the invention, it is provided that the exhaust gas outlet line is thermodynamically connected to a condenser which is designed and connected respectively to the feed line and/or water line such that water condensed therein can accordingly be fed back to the feed line and/or water line. The condenser thus permits the separation of water in the exhaust gas, which water can be reused in the increased-flexibility gas turbine power plant process. This results in an at least partial water circuit for environmentally friendly and efficient water use.

Furthermore, it can be provided according to another embodiment of the invention that the exhaust gas outlet line is thermodynamically coupled to at least two heat stores, wherein the first heat store is provided with a first heat storage medium and the second heat store is provided with a second heat storage medium and, during regular operation, the temperature of the first heat store is not equal to the temperature of the second heat store. Advantageously, the first heat store is designed for example as a hot store whose operating temperature is typically above ambient temperature, that is to say for example between 30° C. and 200° C., and the second heat store is designed as a cold store, whose temperature is typically below ambient temperature, that is to say for example between 0° C. and 30° C. In this context, the temperature limits can vary depending on the ambient temperature. A margin of variation of approximately 10° C. can be assumed in this context.

The increased-flexibility use of the gas turbine during motive operation of the energizing unit permits, in addition to the provision of heat from the exhaust gas stream of the gas turbine, also the provision of a cold stream, namely when the energizing unit is in motive operation and water is added to the compressed air in the compressor or in the combustion chamber prior to expansion in the expander. In this context, there is typically no combustion of fuel in the combustion chamber. The water-air mixture cools as a consequence of the expansion in the expander, which typically makes it possible to achieve temperatures of as low as 0° C. Temperatures below this can indeed also be achieved, but are not desirable during regular operation since the formation of solids (crystallized water) can result in damage to the expander.

Depending on the mode of operation of the gas turbine power plant, it is thus possible to provide heat (from the exhaust gas stream of the gas turbine) or also cold (by carrying out the cold expansion as described above). The heat which in this context can be provided at either of two different temperatures, can according to the embodiment be temporarily stored in two different heat stores, each of which is provided with a heat storage medium. In an alternative to this embodiment, it is also possible to provide just one heat store for both.

According to a development of this inventive concept, it is provided that the first heat store is thermodynamically connected to the exhaust gas outlet line via a first heat exchanger and the second heat store is thermodynamically connected to the exhaust gas outlet line via a second heat exchanger, wherein the first heat exchanger and the second heat exchanger are not identical. The two heat stores can thus be supplied individually via separate heat exchangers or exchange heat with the medium conveyed in the exhaust gas line. This further increases the flexibility of the gas turbine power plant and ensures efficient heat storage. It is alternatively also possible to provide just one heat store and thus accordingly just one heat exchanger in the gas turbine power plant.

In an alternative to this embodiment, it can also be provided that both the first heat store and the second heat store are thermodynamically connected to the exhaust gas outlet line via a first heat exchanger. The two heat stores can thus take in and possibly also give off thermal energy via just one heat exchanger (first heat exchanger). This reduction in components improves the constructive complexity and thus the cost outlay.

According to a further embodiment of the invention, it is provided that there is further provided a bypass line which is fluidically connected to the fluid line and makes it possible to guide at least part of the fluid stream, conveyed in the fluid line, around the recuperator, without the fluid stream taking in or giving off heat in the recuperator. The bypass line makes it possible, in particular during motive operation of the energizing unit, for the recuperator to be bypassed such that the compressed fluid stream fed to the combustion chamber essentially retains its heat content. If the fluid line were namely fed via the recuperator, this could result in a reduction in the heat content since the exhaust gas taken from the exhaust gas line is at a lower temperature.

According to a further embodiment of the invention, it is provided that the fluid line is also fluidically connected to a branch line which makes it possible to guide at least part or indeed all of the fluid stream, conveyed in the fluid line, directly to the first heat exchanger or second heat exchanger for exchange of heat. The branch line can in this context be arranged upstream or downstream of the recuperator. In particular if the branch line is provided upstream, the fluid stream taken from the compressor, which has been heated essentially adiabatically as a consequence of the compression, can be fed directly to the first heat exchanger or to the second heat exchanger for transferring heat to the first heat store or second heat store. Consequently, all of the heat energy in the fluid stream due to the adiabatic heating is available for exchange of heat. It is in this context possible to avoid further thermal conditioning, in particular to a lower temperature.

According to a first development of the method according to the invention, it is provided that furthermore, a further operating phase which is not carried out at the same time as the first or second operating phase comprises the following steps:—operating the energizing unit for motive driving of the compressor;—compressing air by means of the compressor and conveying the compressed air stream, by means of the fluid line and the branch line, to the first heat exchanger;—transferring heat from the compressed air stream to a first heat medium by means of the first heat exchanger and storing the heat medium in the first heat store.

The motive drive of the compressor makes it possible to draw excess current from the current supply grids under economically advantageous conditions, and to convert this electrical energy into thermal energy which can be temporarily stored in the first heat store. Thus, the thermal energy so generated is available for further use, in particular for applications in the field of combined heat and power, provided that, to that end, the heat store is connected to suitable devices. The provision of thermal energy by means of the compressed air flow can also be achieved within relatively short time spans (a few minutes), such that operation takes on an improved degree of flexibility.

According to an alternative or complementary embodiment of the method according to the invention, a further operating phase which is not carried out at the same time as the first, second or third operating phase also comprises the following steps:—operating the energizing unit for motive driving of the compressor;—feeding water, by means of the feed line, to the gas turbine in order to increase the operating mass flow;—compressing fluid by means of the compressor and conveying the compressed fluid stream, by means of the fluid line and the bypass line, to the combustion chamber, bypassing the recuperator;—no or only reduced combustion of a fuel in the combustion chamber;—conveying the compressed fluid stream from the combustion chamber to the expander;—expanding the fluid stream as exhaust gas stream in the expander and removing this by means of the exhaust gas outlet line;—transferring heat from the removed exhaust gas stream to a first or second heat storage medium by means of a first heat exchanger or a second heat exchanger and storing the heat storage medium in the first heat store or the second heat store.

Due to the expansion of the water-containing exhaust gas stream in the expander, it is possible to prepare an exhaust gas stream at a temperature substantially below the temperature that prevails in the exhaust gas stream during conventional operation of the gas turbine. In particular, it is possible to provide heat at a temperature below the ambient temperature, which can for example be temporarily stored as cold (negative thermal energy) in the first or second heat store. In particular when using this method in relatively hot countries, for example close to the equator, it is thus possible to provide cold which can then for example be fed into suitable cooling devices. It is thus for example possible to use the cold temporarily stored in a heat store for domestic or industrial cooling purposes by means of a suitable district cooling network.

In the following, the invention is explained in greater detail with reference to individual figures. In this context, it is to be noted that those technical features with the same reference sign have identical technical effects.

At this point, it is noted that the technical features described below are claimed in isolation and also in any combination with one another, provided that the combination makes it possible to solve the problem upon which the invention is based.

It is also to be noted that the following figures are merely schematic and are to be understood as a functional circuit and thus permit no limiting effect with respect to the enablement of the invention.

### BRIEF DESCRIPTION OF THE DRAWINGS

In the figures:

FIG. 1 shows a first embodiment of the gas turbine power plant 1 according to the invention, corresponding to a first possible operating phase of the method according to the invention;

FIG. 2 shows the embodiment, shown in FIG. 1, of the gas turbine power plant 1 according to the invention, according to another operating phase of the method according to the invention;

FIG. 3 shows the embodiment, shown in FIG. 1 and FIG. 2, of the gas turbine power plant 1 according to the invention, according to another operating phase;

FIG. 4 shows the embodiment, shown in FIG. 1 to FIG. 3, of the gas turbine power plant 1 according to the invention, according to another operating phase;

FIG. 5 shows another embodiment of the gas turbine power plant 1 according to the invention, corresponding to a first operating phase of the method according to the invention;

FIG. 6 shows a representation, in the form of a flow chart, of an embodiment of the method according to the invention for operating a gas turbine power plant 1 according to the embodiments described above and/or below.

### DETAILED DESCRIPTION OF INVENTION

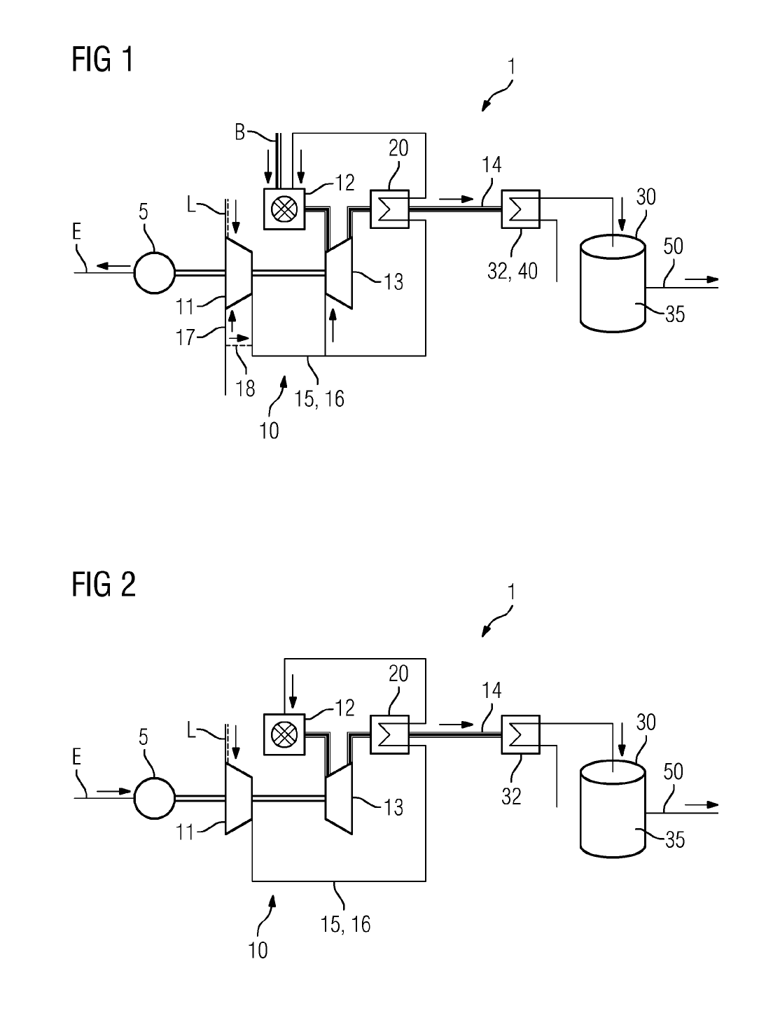

FIG. 1 shows a first embodiment of the gas turbine power plant 1 according to the invention, according to a first operating phase of an embodiment of the method according to the invention for operating same. In this context, the gas turbine power plant 1 comprises a gas turbine 10 which is rotationally coupled to an energizing unit 5. The gas turbine 10 further comprises a compressor 11 into which air L can be drawn during operation. At the same time, water in the gaseous phase or in the liquid phase can be conveyed to the compressor 11 via a feed line 17. Once the air L or the air-water mixture has been compressed to a compressed fluid, this is fed as fluid stream 15 to the combustion chamber 12 via a fluid line 16. For exchange of heat upstream of the combustion chamber 12, there is provided a recuperator 20 which can extract the heat of the exhaust gas stream in the exhaust gas line 14 and can transfer this to the fluid stream 15. The fluid stream 15 thus compressed is mixed in the combustion chamber 12, or already upstream thereof, with the fuel B fed to the combustion chamber 12, and is burnt in the combustion chamber 12. The combustion products are conveyed to the expander 13, by means of which there takes place a thermal expansion with mechanical work being performed simultaneously.

In addition to the transfer of heat from the exhaust gas stream in the exhaust gas line 14 by means of the recuperator 20, there is also a transfer of heat by means of the first heat exchanger 32 which can optionally also comprise a condenser 40 (not explicitly shown here). The heat which is transferred in the first heat exchanger 32 is transferred to a first heat storage medium 35 which can be stored in the first heat store 30. For the purpose of using this heat thus stored, the heat store 30 can have a suitable thermodynamic connection to a district heating network 50 or to another form of heat use device.

As an alternative to the addition of the water by means of the feed line 17 at the compressor, it is also possible for water to be supplied by means of the water line 18 which supplies the water in the steam phase to the fluid line 16.

For thermal conditioning of the combustion products from the combustion chamber 12, expanded by means of the expander 13, it is also possible, via a branch line (not further provided with a reference sign), for a part stream of the fluid stream 15 to be fed directly from the fluid line 16 to the expander. This supports the conversion of thermal energy to rotational energy.

FIG. 2 shows the embodiment already shown in FIG. 1 of the gas turbine power plant 1 according to the invention, which is operated in a second operating phase of an embodiment of the method according to the invention for operating a gas turbine power plant. In contrast to the first operating phase, now no water is supplied to the compressor 11 or to the fluid line 16. At the same time, the energizing unit 5 is in motive operation such that air is drawn into the compressor 11 and is fed, as compressed fluid stream 15 in the fluid line 16, to the combustion chamber 12. Due to the adiabatic heating through compression in the compressor 11, the temperature of the fluid stream is above ambient temperature (up to 250° C.). In the combustion chamber 12, the compressed fluid stream 15 is burnt with fuel B. As an alternative, it is also possible for no supply of fuel B with subsequent combustion in the combustion chamber 12 to take place (shown here). The combustion products removed from the combustion chamber 12 are expanded in the expander 13 and are conveyed, via the exhaust gas line 14, to the first heat exchanger 32. For exchange of heat, it is possible here, depending on the present temperature of the fluid stream 15 and of the exhaust gas stream, for a corresponding exchange of heat to take place in the recuperator 20. By means of the first heat exchanger 32, the heat is in turn transferred to a first heat storage medium 35 in the first heat store 30. The heat is once again available for use by a suitable consumer, for example a district heating network 50.

FIG. 3 shows the embodiment, already shown in FIG. 1 and FIG. 2, of the gas turbine power plant 1, which is operated in a further operating phase not identical to the first and second operating phases. Here, the energizing unit 5 again takes up electrical energy and drives the compressor 11 in motive operation. The intake air L is compressed and is conveyed as fluid stream 15 in the fluid line 16. By means of the branch line 46, which is advantageously connected to the fluid line 16 via a control means (valve) that is not further provided with a reference sign, the fluid stream 15 is conveyed to the first heat exchanger 32 for transfer of heat. There is no provision here for supplying the fluid stream 15 to the combustion chamber 12. Equally, there is no provision for exchange of heat via the recuperator 20. The heat transferred to the first heat storage medium 35 by means of the first heat exchanger 32 can in turn be temporarily stored in the first heat store 30, and made available to a suitable user, for example the district heating network 50.

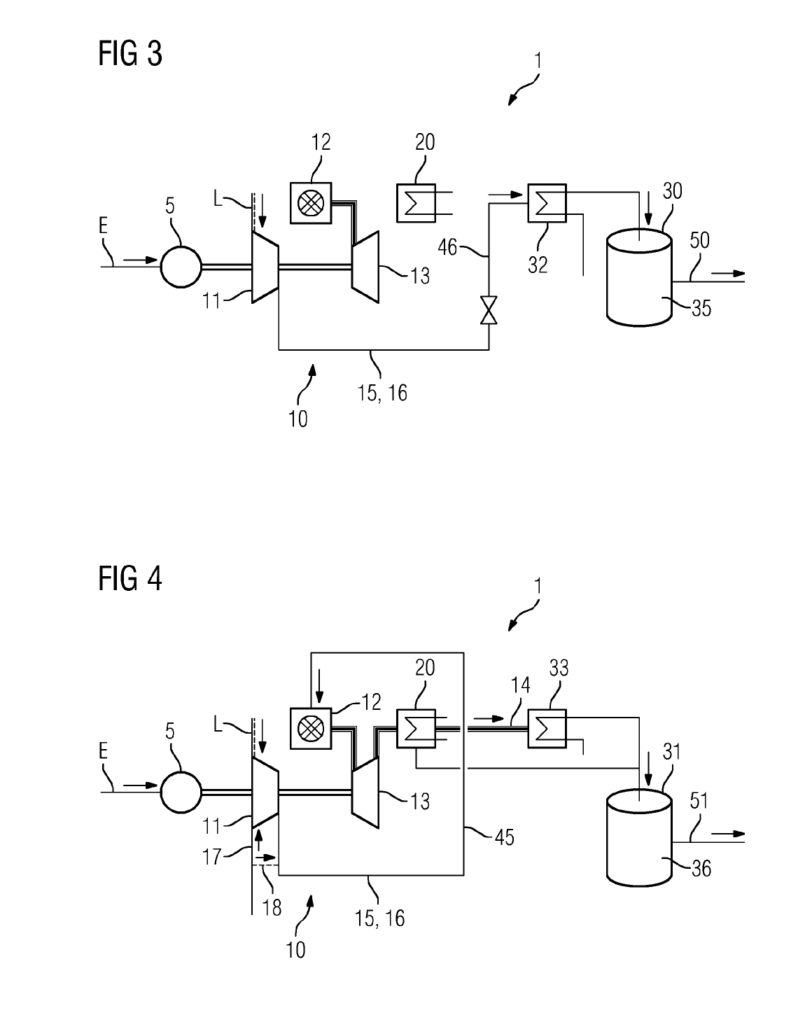

FIG. 4 shows the gas turbine power plant 1 already described in FIGS. 1 to 3, which is operated in a further operating phase not identical to the previously described operating phases shown in FIGS. 1 to 3. According to this, electrical energy E is once again taken up by the energizing unit 5 and used for driving the compressor 11 in rotation. At the same time, water can be added to both the compressor 11 and/or to the fluid line 16 by means of the feed line 17 or water line 18. The air L or the air-water mixture is compressed by means of the compressor 11 and is fed, as fluid stream 15 in the fluid line 16, to the combustion chamber 12. A bypass line 45, which is fluidically connected to the fluid line 16, makes it possible to bypass the recuperator 20. In that context, there is no transfer of heat from or to the fluid stream 15. What is essential for the shown operating phase of the method according to the embodiment is that the fluid stream 15 conveyed to the combustion chamber 12 is wet, that is to say that it has a steam fraction. This fraction is in particular greater than 10% by mass and further in particular not more than 30% by mass. No further combustion takes place in the combustion chamber 12, such that this fluid stream 15 is conveyed directly to the expander 13 for expansion. The expansion and the high water content in the fluid stream result in cooling of the exhaust gas stream to temperatures substantially below ambient temperature. Typical temperatures in this context are between 0 and 30° C. Equally, it is possible to achieve temperatures below 0° C., but these should be avoided since the water within the fluid stream 15 crystallizes out to produce solids which can damage the components of the expander 13.

The exhaust gas stream conveyed in the exhaust gas line 14 can give off only part of its heat (negative thermal energy, cold) to a further fluid stream via the recuperator 20. Cold can also be transferred by means of a second heat exchanger 33 via which the cold is transferred to a second heat storage medium 36 that is stored in a second heat store 31. The second heat store 31 can in this context also be connected to a suitable installation for using cold, for example a district cooling installation 51. According to the embodiment, it is also possible that the first heat store 30 and the second heat store 31 are identical but are charged to a different temperature at different times.

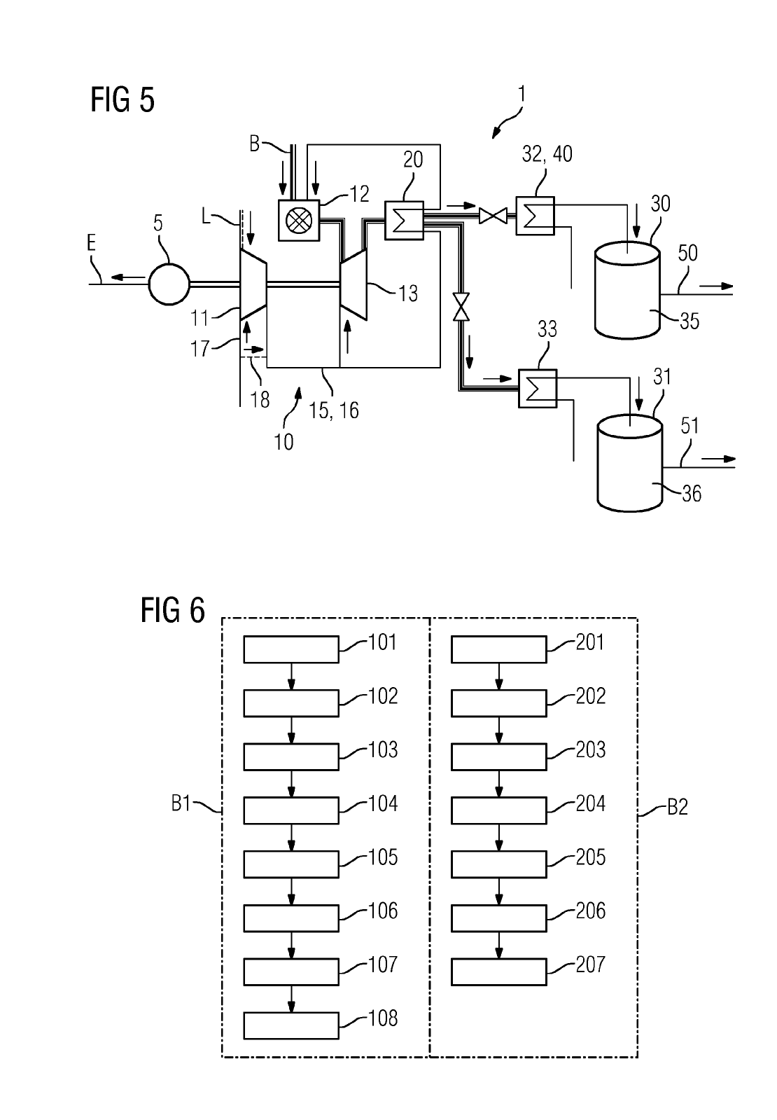

FIG. 5 shows a further embodiment of the gas turbine power plant 1 according to the invention, by means of which an operating phase of an embodiment of the method according to the invention for operating this gas turbine power plant is carried out. With respect to the constructive embodiment, the gas turbine power plant 1 differs from the embodiment shown in FIG. 1 merely in that the recuperator 20 is connected not only to a single heat store but to two heat stores 30 and 31. In this context, advantageously, the first heat store 30 is provided for supplying heat by means of the first heat storage medium 35 at a first temperature T1, and the second heat store 31 for supplying heat by means of the second heat storage medium 36 at a second temperature T2. Both heat stores 30, 31 are each individually connected to the exhaust gas line 14 via a heat exchanger 32, 33. It is equally possible that the exhaust gas line 14 has a branching point, as shown here. Depending on the operating phase, it is thus possible for heat or cold to be supplied to one of the two heat stores 30, 31. Consequently, during operation of the gas turbine power plant, two heat stores at different temperatures T1, T2 can be ready for use.

FIG. 6 shows a representation, in the form of a flow chart, of an embodiment of the method according to the invention for operating a gas turbine power plant 1 as described further above, which comprises the following steps,

during a first operating phase B1:—operating the energizing unit 5 for generative current generation (first method step 101);—feeding water, by means of the feed line 17, to the gas turbine 10 in order to increase the operating mass flow (second method step 102);—compressing fluid by means of the compressor 11 and conveying the compressed fluid stream 15, by means of the fluid line 16, to the combustion chamber 12 (third method step 103);—combusting the compressed fluid together with a fuel in the combustion chamber 12 (fourth method step 104);—conveying the combustion products from the combustion chamber 12 to the expander 13 (fifth method step 105);—expanding the combustion products in the expander 13 and removing the exhaust gas stream from the expander 13 by means of the exhaust gas outlet line 14 (sixth method step 106);—transferring heat from the exhaust gas stream to the fluid of the fluid stream 15 by means of the recuperator 20 (seventh method step 107);—transferring heat from the exhaust gas stream to a first heat storage medium 35 by means of a first heat exchanger 32 and storing the heat storage medium 35 in the first heat store 30 (eighth method step 108);

and during a second operating phase, which is not carried out at the same time as the first operating phase:—operating the energizing unit 5 for motive driving of the compressor 11 (first method step 201);—compressing air by means of the compressor 11 and conveying the compressed air stream 15, by means of the fluid line 16, to the combustion chamber 12 (second method step 202);—combusting the compressed air together with a fuel in the combustion chamber 12 (third method step 203);—conveying the combustion products from the combustion chamber 12 to the expander 13 (fourth method step 204);—expanding the combustion products in the expander 13 and removing the exhaust gas stream by means of the exhaust gas outlet line 14 (fifth method step 205);—transferring heat from the exhaust gas stream to the fluid stream 15 by means of the recuperator 20 (sixth method step 206);—transferring heat from the exhaust gas stream to a first heat storage medium 35 by means of the first heat exchanger 32 and storing the heat medium 35 in the first heat store 30 (seventh method step 207).

Further embodiments are to be found in the subclaims.

1.-12. (canceled)

13. A gas turbine power plant, comprising
a gas turbine having a compressor, a combustion chamber and an expander, the gas turbine being rotationally coupled to an energizing unit, wherein the energizing unit is designed both for motive operation of the compressor and for current-generating, generative operation of the gas turbine,
a recuperator which is thermodynamically connected to an exhaust gas outlet line of the gas turbine such that, during operation of the gas turbine, heat from the exhaust gas stream in the exhaust gas outlet line is transferred to a fluid stream, in a fluid line, which is fed to the combustion chamber, wherein the fluid stream in the fluid line is essentially compressed air, and the fluid line is fluidically connected to the compressor, and
a feed line for water which is fluidically connected to the gas turbine such that water can be fed to the gas turbine during operation in order to increase the operating mass flow, and
wherein the exhaust gas outlet line is thermodynamically coupled to at least one heat store such that, during operation of the gas turbine, heat from the exhaust gas stream can be transferred to a heat storage medium to be stored in the heat store.

14. The gas turbine power plant as claimed in claim 13, further comprising:
a water line which opens into the fluid line and, during operation of the gas turbine, can supply water to the fluid stream in the fluid line.

15. The gas turbine power plant as claimed in claim 13,
wherein the exhaust gas outlet line is thermodynamically connected to a condenser which is designed and connected respectively to the feed line and/or water line such that water condensed therein can accordingly be fed back to the feed line and/or water line.

16. The gas turbine power plant as claimed in claim 13,
wherein the exhaust gas outlet line is thermodynamically coupled to at least two heat stores, wherein the first heat store is provided with a first heat storage medium and the second heat store is provided with a second heat storage medium and, during regular operation, the temperature (T1) of the first heat store is not equal to the temperature (T2) of the second heat store.

17. The gas turbine power plant as claimed in claim 16,
wherein the first heat store is thermodynamically connected to the exhaust gas outlet line via a first heat exchanger and the second heat store is thermodynamically connected to the exhaust gas outlet line via a second heat exchanger, wherein the first heat exchanger and the second heat exchanger are not identical.

18. The gas turbine power plant as claimed in claim 16,
wherein both the first heat store and the second heat store are thermodynamically connected to the exhaust gas outlet line via a first heat exchanger.

19. The gas turbine power plant as claimed in claim 13, further comprising:
a bypass line which is fluidically connected to the fluid line and to guide at least part of the fluid stream, conveyed in the fluid line, around the recuperator, without the fluid stream taking in or giving off heat in the recuperator.

20. The gas turbine power plant as claimed in claim 18,
wherein the fluid line is also fluidically connected to a branch line to guide at least part or all of the fluid stream, conveyed in the fluid line, directly to the first heat exchanger or second heat exchanger for exchange of heat.

21. A method for operating a gas turbine power plant as claimed in claim 13, comprising the following steps,
during a first operating phase:
operating the energizing unit for generative current generation;
feeding water, by means of the feed line, to the gas turbine in order to increase the operating mass flow;
compressing fluid by means of the compressor and conveying the compressed fluid stream, by means of the fluid line, to the combustion chamber;
combusting the compressed fluid together with a fuel in the combustion chamber;
conveying the combustion products from the combustion chamber to the expander;
expanding the combustion products in the expander and removing the exhaust gas stream from the expander by means of the exhaust gas outlet line;
transferring heat from the exhaust gas stream to the fluid of the fluid stream by means of the recuperator;
transferring heat from the exhaust gas stream to a first heat storage medium by means of a first heat exchanger and storing the heat storage medium in the first heat store; and
during a second operating phase, which is not carried out at the same time as the first operating phase:
operating the energizing unit for motive driving of the compressor;
compressing air by means of the compressor and conveying the compressed air stream, by means of the fluid line, to the combustion chamber;
combusting the compressed air together with a fuel in the combustion chamber;
conveying the combustion products from the combustion chamber to the expander;
expanding the combustion products in the expander and removing the exhaust gas stream by means of the exhaust gas outlet line;
transferring heat from the exhaust gas stream to the fluid stream by means of the recuperator;
transferring heat from the exhaust gas stream to a first heat storage medium by means of the first heat exchanger and storing the heat medium in the first heat store.

22. The method as claimed in claim 21, further comprising:
a further operating phase which is not carried out at the same time as the first or second operating phase, comprising the following steps:
operating the energizing unit for motive driving of the compressor;
compressing air by means of the compressor and conveying the compressed air stream, by means of the fluid line and the branch line, to the first heat exchanger;
transferring heat from the compressed air stream to a first heat medium by means of the first heat exchanger and storing the heat medium in the first heat store.

23. The method as claimed in claim 21, further comprising:
a further operating phase which is not carried out at the same time as the first, second or third operating phase, comprising the following steps:
operating the energizing unit for motive driving of the compressor;
feeding water, by means of the feed line, to the gas turbine in order to increase the operating mass flow;
compressing fluid by means of the compressor and conveying the compressed fluid stream, by means of the fluid line and the bypass line, to the combustion chamber, bypassing the recuperator;
no or only reduced combustion of a fuel in the combustion chamber;
conveying the compressed fluid stream from the combustion chamber to the expander;
expanding the fluid stream as exhaust gas stream in the expander and removing this by means of the exhaust gas outlet line;
transferring heat from the removed exhaust gas stream to a first or second heat storage medium by means of a first heat exchanger or a second heat exchanger and storing the heat storage medium in the first heat store or the second heat store.
